(19) United States
(12) Patent Application Publication
(10) Pub. No.: US 2018/0045413 A1
(43) Pub. Date: Feb. 15, 2018

(54) COMBUSTION CHAMBER OF A TURBINE ENGINE COMPRISING A THROUGH-PART WITH AN OPENING

(71) Applicant: SAFRAN HELICOPTER ENGINES, Bordes (FR)

(72) Inventors: Olivier LAMAISON, Montardon (FR); Nicolas SAVARY, Jurancon (FR)

(73) Assignee: SAFRAN HELICOPTER ENGINES, Bordes (FR)

(21) Appl. No.: 15/552,056

(22) PCT Filed: Feb. 23, 2016
(86) PCT No.: PCT/FR2016/050411

§ 371 Date: Aug. 18, 2017

(30) Foreign Application Priority Data
Feb. 25, 2015 (FR) 15 51600

(51) Int. Cl. F23R 3/04

(52) U.S. Cl. CPC F23R 3/045; F23R 2900/03042; F02C 7/266

(57) ABSTRACT

A combustion chamber of a turbine engine, including at least one wall defining the combustion chamber and including an aperture for enabling a through-part to pass therethrough. The through-part includes, in the portion thereof located within the combustion chamber, at least one opening able to create an air film to cool the area downstream of the through-part.

### TECHNICAL FIELD

The present invention relates to the field of turbine engines, and more particularly to the general field of combustion chambers of turbine engines.

The invention applies to any type of land or aeronautical turbine engines, and especially to the aircraft turbine engines such as turbojets and turboprop engines.

It more precisely relates to a combustion chamber of a turbine engine comprising a wall fitted with a through-part in the combustion chamber which comprises an opening to create an air flow for cooling the wall, as well as a turbine engine comprising a compressor and such a chamber.

### STATE OF PRIOR ART

FIG. 1 illustrates a typical example of a turbine engine 10 of a known type, for example an aircraft twin-spool turbofan engine.

The turbine engine 10 comprises, successively along the thrust direction depicted by the arrow F which also corresponds to the general flowing direction of gases in the turbojet engine, a low pressure compressor 11, a high pressure compressor 12, an annular combustion chamber 1, a high pressure turbine 13 and a low pressure turbine 14.

In a well-known manner, a combustion chamber 1 is mounted downstream of the high pressure compressor 12 intended to supply this chamber with pressurised air, and upstream of the high pressure turbine 13 intended to rotate the high pressure compressor 12 under the thrust effect of gases coming from the combustion chamber.

FIG. 2 illustrates on a large scale a combustion chamber 1 and its immediate surrounding.

The combustion chamber 1 comprises two respectively radially inner 2 and radially outer 3 coaxial annular walls, which extend about the longitudinal axis T of the combustion chamber 1.

These two annular walls 2 and 3 are fastened downstream to inner 5 and outer 6 casings of the chamber 1, and are connected to each other at their upstream end by a chamber bottom annular wall 4.

The chamber bottom annular wall 4 comprises an annular row of apertures evenly distributed about the axis T of the combustion chamber 1, and in which are mounted injection systems 7 associated with an annular row of fuel injectors 8 each having a fuel emitting axis 9.

Each injection system 7 comprises apertures intended for injecting, in the combustion chamber 1, a portion of the air flow coming from the diffuser (not represented) mounted at the outlet of the high pressure compressor 12 of the turbine engine 10.

Besides, the annular walls 2 and 3 of the combustion chamber 1 are connected at their upstream end to an annular fairing 17 comprising apertures aligned with the injection systems 7 for passing injectors 8 and air supplying the injection systems 7. The main functions of this fairing 17 is to protect the chamber bottom wall 4 and to guide portions 18 and 19 of the air flow coming from the diffuser which travel downstream respectively along the inner 2 and outer 3 annular walls of the combustion chamber 1, within two respectively inner 20 and outer 21 bypass spaces. These portions 18 and 19 of the air flow are respectively referred to as “inner bypass air flow” and “outer bypass air flow”. The inner 20 and outer 21 bypass spaces form, with an upstream space 22 which connects one to the other, an enclosure in which the combustion chamber 1 extends.

Furthermore, the radially outer annular wall 3 comprises an aperture 30 for enabling a plug to pass therethrough, having an axis 27, and fitted with a cooling bushing 28 in which a spark plug 29 extends, mounted on the outer casing 6 and intended to initiate the combustion of the air and fuel mixture at the turbine engine start. As an alternative, the plug aperture 30 could also be located on the chamber bottom wall 4 or on the radially inner annular wall 2.

The inner temperature of the combustion chamber 1 is such that it is often necessary to create a cooling air film between the flame and the radially outer wall 3 of the chamber in order to significantly increase its lifetime.

To do so, the inner surface 3a of the radially outer wall 3 can be provided with longitudinal tongues 31a, 31b enabling an air film to be generated, as shown in FIG. 3 which is a partial perspective view of the inside of a combustion chamber 1 such as the one of FIGS. 1 and 2.

However, in some cases, obstacles such as the cooling bushing 28 of the spark plug 29 represented in FIGS. 2 and 3, may suddenly cut off this protecting air film. Then, the temperature downstream of the cooling bushing 28 is no longer homogeneous and the cooling bushing 28 generates a hot wake 32 within the outer bypass air flow 19, as illustrated in FIG. 4.

Of course, other types of elements penetrating in the combustion chamber 1, other than a cooling bushing, can be obstacles to the flow of the protecting air film, such as for example fastening axes or starting injectors.

The wake 32 can then cause considerable temperature gradients, in the order of several hundreds of Celsius degrees, on a very short distance, in the order of a few millimetres. This can then result in a reduction of the lifetime of the radially outer wall 3.

This wake 32 develops downstream by being centred with respect to a medium axial plane P of the plug aperture 30, in the case where the air flow coming from the diffuser provided by the high pressure compressor 12 flows downstream substantially with no spinning component.

On the contrary, in the case where the air flow provided by the high pressure compressor 12 flows downstream in a helical pattern, that is with a spinning component, the wake 32 develops downstream generally along a tilted direction with respect to the medium axial plane P of the plug aperture 30.

It is to be noted that “axial plane” is meant to signify a plane passing through the axis T (see FIG. 2) of the combustion chamber 1, which merges with the turbine engine axis. It is to be noted that the plane P corresponds to the section plane of FIG. 2.

In any cases, the wake 32 results in a depression in the region of the outer bypass air flow 19 covered by the cooling bushing 28 of the plug.

Given the presence of such a wake 32 on the radially outer wall 3, it is necessary to locally cool the area downstream of the cooling bushing 28 by reconstructing an air film.

Solutions have been suggested aiming, in some configurations, at adding a multitude of micro-perforations 33 (multi-drill) aiming at cooling the downstream area of the cooling bushing 28. In the example of FIG. 4, these micro-perforations 33 are substantially distributed across the surface of the radially outer wall 3 and are intended to create a cooling air film along this wall 3 within the combustion chamber 1. For the sake of clarity, these micro-perforations 33 are represented larger and distributed according to a lesser density than in reality.

Nevertheless, the addition of such micro-perforations 33 dictates additional operations to be performed during manufacture. Moreover, the air film reconstructed through micro-perforations 33 does not have the same streamline flow as an air film generated using longitudinal tongues 31a, 31b.

### DISCLOSURE OF THE INVENTION

There is therefore a need to provide an alternative solution for cooling a wall of a turbine engine combustion chamber in order to increase its lifetime, reducing at best the temperature gradients and the local hot points.

The purpose of the invention is to overcome at least partially the above-mentioned needs and the drawbacks related to prior art implementations.

The purpose of the invention is thus, according to one of the aspects thereof, a combustion chamber of a turbine engine, comprising at least one wall, especially an annular or toroidal wall, defining the combustion chamber and comprising an aperture for enabling a through-part to pass in the combustion chamber, characterised in that the through-part comprises, in the portion thereof located within the combustion chamber, at least one opening able to create an air film for cooling the area downstream of the through-part.

The invention makes it possible to enable an efficient cooling of the wall of the combustion chamber of the turbine engine by creating an air film downstream of the through-part. This way, it can also be possible to limit the appearance of hot wakes on the wall of the combustion chamber downstream of the through-part. Thus, the invention can enable the lifetime of the combustion chamber to be significantly increased. Moreover, the invention can be implemented in a simple way, avoiding the addition of additional operations and/or components on the combustion chamber. The air film can indeed be recreated simply by adding an opening on the through-part with a low added value. Furthermore, the solution of the invention can make it possible to recreate an air film substantially equivalent in terms of streamline flow to the air film generated by the tongue(s) such as previously described.

The combustion chamber according to the invention can further include one or more of the following characteristics taken individually or according to any possible technical combinations.

Said at least one opening of the through-part can be made for example by machining.

Preferably, said at least one opening of the through-part corresponds to a slot made on the surface of the through-part, especially of an oblong shape.

Furthermore, said at least one opening of the through-part can extend longitudinally along the annular edge of the through-part, especially over at least one quarter of the annular edge of the through-part.

Said at least one opening of the through-part can be substantially formed at the radially inner end of the through-part.

Besides, said at least one opening of the through-part can extend substantially parallel to the direction of the cooling air flow supplying it.

Said at least one wall can comprise the radially outer annular wall of the combustion chamber. Said at least one wall can yet comprise the radially inner annular wall of the combustion chamber. Said at least one wall can also comprise the chamber bottom annular wall.

Besides, the inner surface of said at least one wall can comprise at least one tongue able to generate an air film for cooling said at least one wall, and especially two tongues extending substantially parallel to each other, the through-part being located between both tongues.

Moreover, said at least one wall can comprise a plurality of micro-perforations to enable an inlet of cooling air in the combustion chamber for cooling said at least one wall.

The through-part can be any type of element penetrating the combustion chamber and thus constituting an obstacle to the flow of a protective air film. It can especially be a fastening axis or a starting injector. However, preferentially, the through-part is a cooling bushing of a spark plug.

Besides, the purpose of the invention is also, according to another of its aspects, a turbine engine, characterised in that it comprises a compressor, especially a high pressure compressor, and a combustion chamber such as previously defined, disposed into an annular enclosure arranged at the outlet of the compressor, and in which a portion of an air flow coming from the compressor is intended to bypass the combustion chamber along said at least one wall.

The combustion chamber and the turbine engine according to the invention can comprise any of the previously stated characteristics, taken individually or according to any technically possible combinations with other characteristics.

### BRIEF DESCRIPTION OF THE DRAWINGS

The invention can be better understood upon reading the following detailed description of a non-limiting implementation example thereof, as well as upon studying the schematic partial figures of the accompanying drawing, in which:

FIG. 1 is an axial cross-section view, of a turbine engine of a known type,

FIG. 2 is an axial cross-section half view, of an annular combustion chamber of the turbine engine of FIG. 1,

FIG. 3 is a partial perspective view of the inside of a combustion chamber such as the one represented in FIGS. 1 and 2,

FIG. 4 is a top view of a radially outer annular wall of the combustion chamber of FIG. 2,

FIG. 5 is a partial cross-section half view of an annular combustion chamber of the turbine engine according to an exemplary implementation of the invention, the cooling bushing being represented in a cross-section,

FIG. 6 is an another perspective cross-section view of the annular combustion chamber of FIG. 5, the cooling bushing being represented in a perspective cross-section view, the plug being not represented, and

FIG. 7 represents an isolated perspective view of the cooling bushing located between the radially outer wall and the chamber bottom wall of the combustion chamber of FIGS. 5 and 6.

Throughout these figures, identical references may refer to identical or analogous elements.

Moreover, the different parts represented in the figures are not necessarily drawn to a uniform scale, in order to make the figures more understandable.

### DETAILED DISCLOSURE OF A PARTICULAR EMBODIMENT

Throughout the description, it is to be noted that the terms upstream and downstream are to be considered relative to a main direction F of normal flow of gases (from upstream to downstream) for a turbine engine 10. Besides, the axis T of the turbine engine 10 is referred to as the axis of radial symmetry of the turbine engine 10. The axial direction of the turbine engine 10 corresponds to the direction of the axis T of the turbine engine 10. A radial direction of the turbine engine 10 is a direction perpendicular to the axis T of the turbine engine 10. Furthermore, unless otherwise specified, the adjectives and adverbs axial, radial, axially and radially are used in reference to the above-mentioned axial and radial directions. Moreover, unless otherwise specified, the terms inside and outside are used in reference to a radial direction so that the inside portion of an element is closer to the axis T of the turbine engine 10 than the outside portion of the same element.

Moreover, in the following description, it is considered that the through-part 28 is a cooling bushing 28 of a spark plug 29. This choice is of course in no way limiting, since the through-part 28 can be any element penetrating the combustion chamber 1 and constituting an obstacle to the flow of a protecting air film, such as a fastening axis or a starting injector.

Furthermore, the wall 3 defining the combustion chamber 1 and comprising an aperture 30 for enabling the through-part 28 to pass therethrough preferentially consists in the radially outer annular wall 3 of the combustion chamber 1. However, this wall can also consist in the chamber bottom annular wall 4 or the radially inner annular wall 2 of the combustion chamber 1.

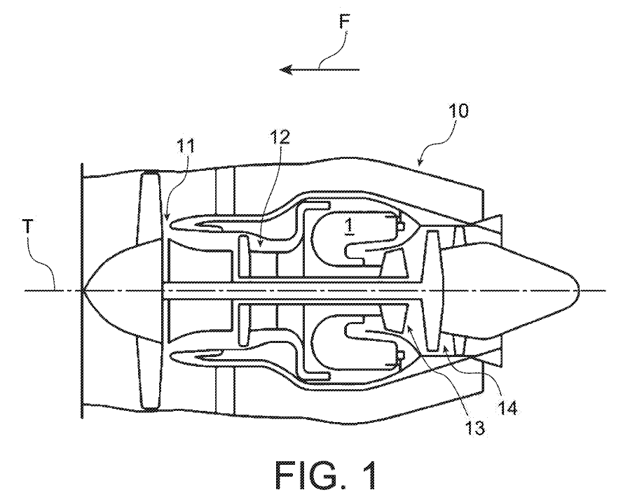

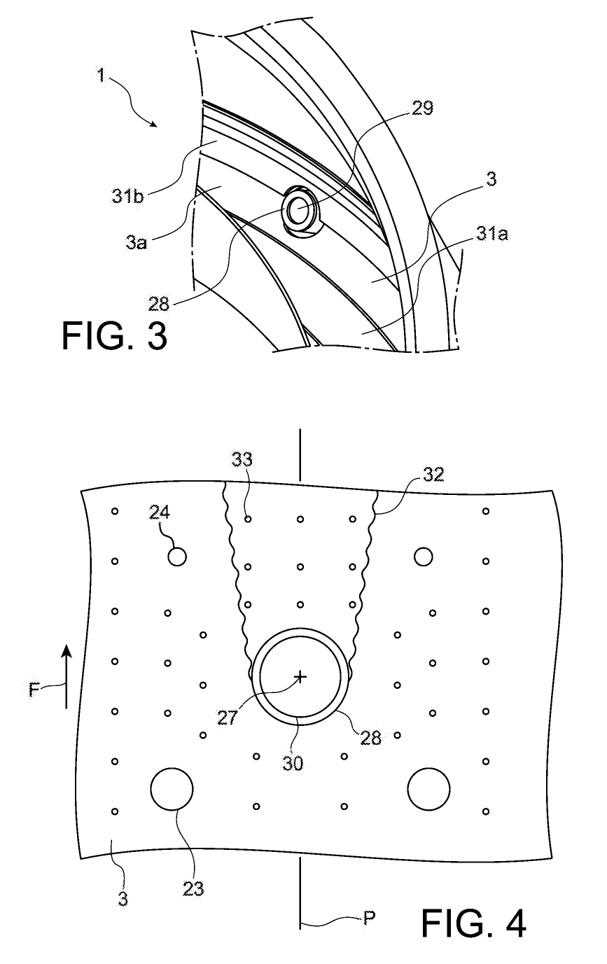

FIGS. 1 to 4 have already been previously described in the portion related to the state of prior art.

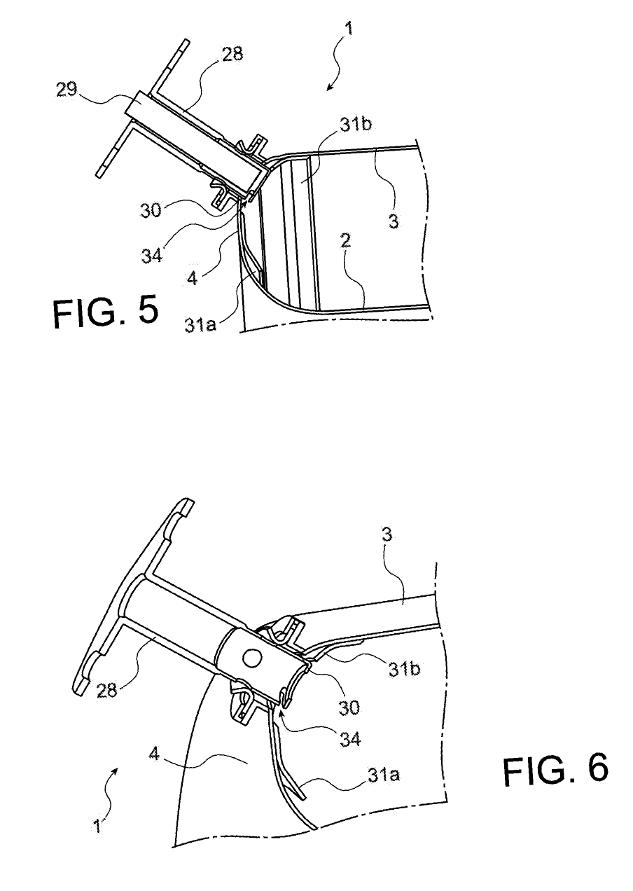

With reference to FIGS. 5 to 7, an exemplary embodiment of a combustion chamber 1 in accordance with the invention is beside illustrated.

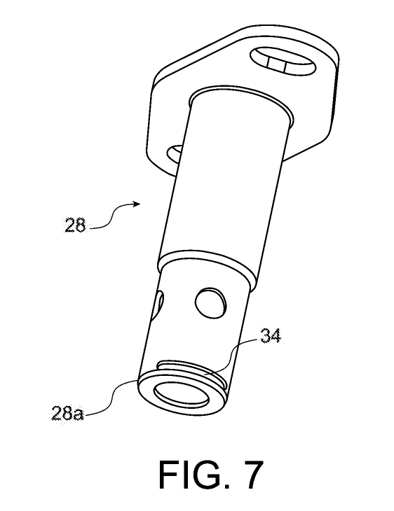

More precisely, FIGS. 5 and 6 are perspective views of the radially outer annular wall 3 and of the chamber bottom wall 4 of the combustion chamber 1 of the turbine engine, the cooling bushing 28 of the plug 29 being respectively represented in a cross-section and perspective view. Moreover, FIG. 7 represents, in an isolated perspective view, this cooling bushing 28.

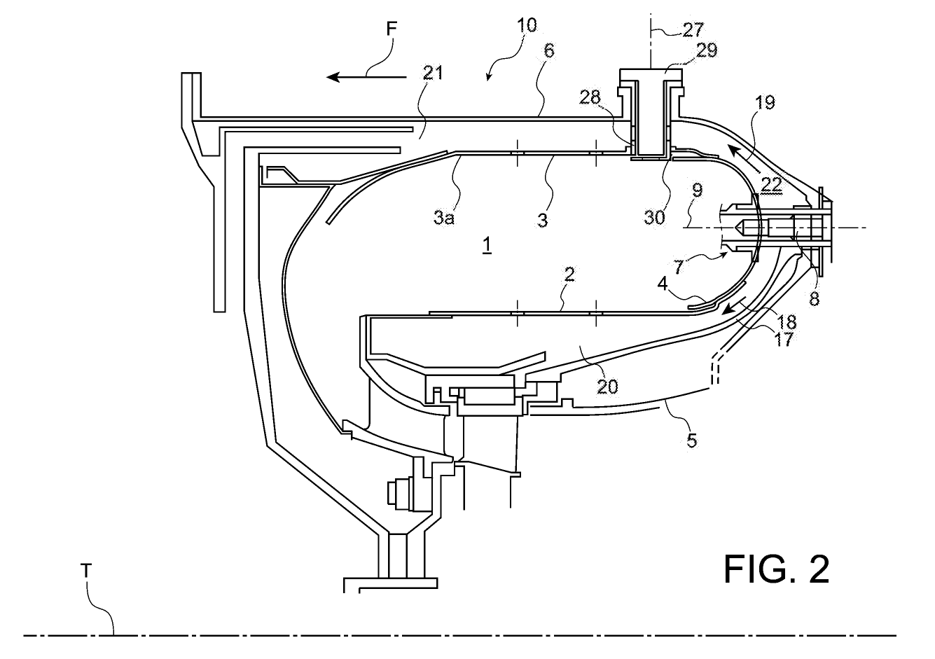

The combustion chamber 1 is similar to the one previously described with reference to FIGS. 1 to 4, the cooling bushing 28 being nevertheless modified according to the invention in order to improve the cooling efficiency of the chamber bottom annular wall 4, as shown in FIGS. 5 and 6, whereas the improvement concerned the cooling efficiency of the radially outer annular wall 3 for the example of FIG. 2.

Thus, the radially outer annular wall 3 of the combustion chamber 1 comprises an aperture 30 enabling the cooling bushing 28 of the spark plug 29 to pass therethrough.

According to the invention, the cooling bushing 28 comprises, in the portion thereof located inside the combustion chamber 1, an opening 34 able to create an air film for cooling the area downstream of the cooling bushing 28.

As can be seen in FIGS. 5 to 7, this opening 34 has the form of an oblong shaped slot, machined on the surface of the cooling bushing 28 at the radially inner end 28a thereof.

This slot 34 makes it possible to create an air film downstream of the cooling bushing 28 and of the spark plug 29, so as to prevent, or at least to limit, hot wakes such as previously described from being formed, and therefore to be able to increase the lifetime of the combustion chamber 1.

Besides, as can be seen in FIGS. 5 and 6, the slot 34 of the cooling bushing 28 extends longitudinally along the annular edge of the cooling bushing 28, over at least one quarter of the same. Moreover, this slot 34 extends substantially parallel to the direction of the cooling air flow supplying it.

Furthermore, as represented in FIGS. 5 and 6, the inner surface of the radially outer wall 3 and the inner surface of the chamber bottom 4 respectively comprise a longitudinal tongue 31b and 31a, parallel to each other and between which the cooling bushing 28 of the spark plug 29 is located.

Of course, the invention is not limited to the exemplary embodiment which has just been described. Various modifications can be brought by those skilled in the art.

In particular, generally and as previously indicated, the invention can also be applied to a radially inner annular wall or a combustion chamber bottom annular wall when such a wall is passed through by a spark plug or any other element penetrating a combustion chamber.

The term “comprising a/an” must be understood as being synonymous with “comprising at least one”, unless otherwise specified.

1. A combustion chamber of a turbine engine, comprising at least one wall defining the combustion chamber and comprising an aperture for enabling a through-part to pass therethrough, said through-part comprising, in the portion thereof located within the combustion chamber, at least one opening able to create an air film for cooling the area downstream of the through-part, wherein the inner surface of said at least one wall includes two tongues extending parallel to each other, able to generate an air film for cooling said at least one wall, the through-part being located between both tongues.

2. The combustion chamber according to claim 1, wherein said at least one opening of the through-part corresponds to a slot made on the surface of the through-part especially of an oblong shape.

3. The combustion chamber according to claim 1, wherein said at least one opening of the through-part extends longitudinally along the annular edge of the through-part, over at least one quarter of the annular edge of the through-part.

4. The combustion chamber according to claim 1, wherein said at least one opening of the through-part is formed at the radially inner end of the through-part.

5. The combustion chamber according to claim 1, wherein said at least one opening of the through-part extends parallel to the direction of the cooling air flow supplying it.

6. The combustion chamber according to claim 1, wherein said at least one wall comprises the radially outer annular wall of the combustion chamber.

7. The combustion chamber according to claim 1, wherein said at least one wall comprises the radially inner annular wall of the combustion chamber.

8. The combustion chamber according to claim 1, wherein said at least one wall comprises the chamber bottom annular wall of the combustion chamber.

9. The combustion chamber according to claim 1, wherein said at least one wall comprises a plurality of micro-perforations to enable an inlet of cooling air in the combustion chamber for cooling said at least one wall.

10. The combustion chamber according to claim 1, wherein said through-part is a cooling bushing for a spark plug.

11. A turbine engine, comprising a compressor, and a combustion chamber according to claim 1, disposed in an annular enclosure arranged at the outlet of the compressor, and wherein a portion of an air flow coming from the compressor is intended to bypass the combustion chamber along said at least one wall.
